(19) United States
(12) Patent Application Publication
(10) Pub. No.: US 2023/0386176 A1
(43) Pub. Date: Nov. 30, 2023

(54) METHOD FOR CLASSIFYING AN INPUT IMAGE REPRESENTING A PARTICLE IN A SAMPLE

(71) Applicants: BIOMERIEUX, Marcy L'etoile (FR); BIOASTER, Lyon (FR)

(72) Inventors: Pierre MAHÉ, Lans En Vercors (FR); Meriem EL AZAMI, L’arbresle (FR); Elodie DEGOUT-CHARMETTE, Toussieux (FR); Zohreh SEDAGHAT, La Mulatiere (FR); Quentin JOSSO, Lyon (FR); Fabian ROL, La Verpilliere (FR)

(73) Assignees: BIOASTER, Lyon (FR); BIOMERIEUX, Marcy L'etoile (FR)

(21) Appl. No.: 18/031,972

(22) PCT Filed: Oct. 19, 2021
(86) PCT No.: PCT/FR2021/051821

§ 371 Date: Apr. 14, 2023

(30) Foreign Application Priority Data
Oct. 20, 2020 (FR) FR2010743

(51) Int. Cl. G06V 10/764; G06T 7/11; G06V 10/24; G06V 10/771; G06V 20/69

(52) U.S. Cl. CPC G06V 10/764; G06T 7/11; G06V 10/24; G06V 10/771; G06V 20/69; G06V 2201/07; G06T 2207/20084; G06T 2207/20132

(57) ABSTRACT

A method for classifying at least one input image representing a target particle in a sample involves implementing, by data processing a client, steps of: (B) extracting a characteristic map of the target particle from the input image; (c) reducing the number of variables in the extracted characteristic map, using the t-SNE algorithm; (d) classifying, unsupervised, the input image based on the characteristic map having a reduced number of variables.

### CROSS-REFERENCE TO RELATED APPLICATIONS

This application is a national phase entry of PCT Patent Application Serial No. PCT/FR2021/051821 filed on Oct. 19, 2021, which claims priority to French Patent Application Serial No. FR2010743 filed on Oct. 20, 2020, both of which are incorporated by reference herein.

### TECHNICAL FIELD

The present invention relates to the field of optical acquisition of biological particles. The biological particles may be microorganisms such as bacteria, fungi or yeasts for example. It may also be a question of cells, multicellular organisms, or any other type of particle such as pollutants or dust.

The invention is particularly advantageously applicable to analysis of the state of a biological particle, for example with a view to determining the metabolic state of a bacterium following application of an antibiotic. The invention makes it possible, for example, to carry out an antibiogram on a bacterium.

### BACKGROUND

An antibiogram is a laboratory technique aimed at testing the phenotype of a bacterial strain against one or more antibiotics. An antibiogram is conventionally carried out by culturing a sample containing bacteria and an antibiotic.

European patent application No. 2 603 601 describes a method for carrying out an antibiogram involving visualizing the state of the bacteria after an incubation period in the presence of an antibiotic. To visualize the bacteria, the bacteria are labeled with fluorescent markers allowing their structures to be revealed. Measurement of the fluorescence of the markers then makes it possible to determine whether the antibiotic has acted effectively on the bacteria.

The conventional process for determining antibiotics that are effective against a given bacterial strain consists in taking a sample containing said strain (e.g. from a patient, an animal, a food batch, etc.) then sending the sample to an analysis center. When the analysis center receives the sample, it first cultures the bacterial strain to obtain at least one colony thereof, this taking between 24 hours and 72 hours. It then prepares, from this colony, several samples comprising different antibiotics and/or different concentrations of antibiotics, then again incubates the samples. After a new period of culturing, which also takes between 24 and 72 hours, each sample is analyzed manually to determine whether the antibiotic has acted effectively. The results are then sent back to the practitioner so that he may apply the most effective antibiotic and/or antibiotic concentration.

However, the labeling process is particularly long and complex to perform and these chemical markers have a cytotoxic effect on bacteria. Hence, this visualizing method does not allow bacteria to be observed a number of times during their culture, and as a result the bacteria must be cultured for long enough, about 24 to 72 hours, to guarantee the reliability of the measurement. Other methods of visualizing biological particles use a microscope, allowing non-destructive measurement of a sample.

Digital holographic microscopy or DHM is an imaging technique that allows the depth-of-field constraints of conventional optical microscopy to be overcome. Schematically, it consists in recording a hologram formed by interference between light waves diffracted by the observed object and a spatially coherent reference wave. This technique is described in the review article by Myung K. Kim entitled “Principles and techniques of digital holography microscopy” published in SPIE Reviews Vol. 1, No. 1, January 2010.

Recently, it has been proposed to use digital holographic microscopy to identify microorganisms in an automated manner. Thus, international application WO2017/207184 describes a method for acquiring a particle, this method associating simple defocused acquisition with digital focus reconstruction so as to make it possible to observe a biological particle while limiting acquisition time.

Typically, this solution makes it possible to detect structural modifications to a bacterium in the presence of an antibiotic after an incubation of only about ten minutes, and the sensitivity thereof after two hours (detection of the presence or absence of division or a pattern indicating division), unlike the conventional process described above, which may take several days. Specifically, since the measurements are non-destructive, it is possible to carry out analyses very early on in the culturing process without running the risk of destroying the sample and therefore of prolonging the analysis time.

It is even possible to track a particle over a plurality of successive images so as to form a film representing the progress of a particle over time (since the particles are not spoiled after the first analysis) in order to visualize its behavior, for example its speed of movement or its process of cell division.

It will therefore be understood that this visualizing method gives excellent results. The difficulty lies in the interpretation of these images or this film per se, for example if it is desired to reach a conclusion as to the susceptibility of a bacterium to the antibiotic present in the sample.

Various techniques have been proposed, ranging from simply counting bacteria over time to so-called morphological analysis, which aims to detect particular “configurations” via image analysis. For example, when a bacterium is preparing to divide, two poles appear in the distribution, well before the division itself which results in the distribution dividing into two distinct segments.

It has been proposed in the article [Choi et al. 2014] to combine these two techniques to assess antibiotic effectiveness. However, as underlined by the authors, their approach requires very fine calibration of a certain number of thresholds that strongly depend on the nature of the morphological changes caused by the antibiotics.

More recently, the article [Yu et al. 2018] has described an approach based on deep learning. The authors propose to extract morphological features and features related to the movement of bacteria using a convolutional neural network (CNN). However, this solution turns out to be very intensive in terms of computing resources, and requires a vast database of training images to train the CNN.

The objective technical problem of the present invention is, therefore, that of making it possible to provide a solution for classifying images of a biological particle that is both more effective and less resource intensive.

### SUMMARY

According to a first aspect, the present invention relates to a method for classifying at least one input image representing a target particle in a sample, the method being characterized in that it comprises implementation, by data-processing means of a client, of steps of:
(b) extraction of a feature map of said target particle from the input image;
(c) reduction of the number of variables of the extracted feature map, by means of the t-SNE algorithm;
(d) unsupervised classification of said input image depending on said feature map having a reduced number of variables.

According to advantageous but non-limiting features:

The particles are represented in a uniform manner in the input image and in each elementary image, and in particular centered on and aligned in a predetermined direction.

The method comprises a step (a) of extracting said input image from an overall image of the sample, so as to represent said target particle in said uniform manner.

Step (a) comprises segmentation of said overall image so as to detect said target particle in the sample, then cropping of the input image to said detected target particle.

Step (a) comprises obtaining said overall image from an intensity image of the sample, said image being acquired by an observing device.

Said feature map is a vector of numerical coefficients each associated with one elementary image of a set of elementary images each representing a reference particle, step (a) comprising determination of numerical coefficients such that a linear combination of said elementary images weighted by said coefficients approximates the representation of said target particle in the input image.

Said feature map of said target particle is extracted in step (b) by means of a convolutional neural network trained beforehand on a public image database.

Step (c) comprises, by means of said t-SNE algorithm, definition of an embedding space for each feature map of a training database of already classified feature maps of particles in a sample and for the extracted feature map, said feature map having a reduced number of variables being the result of embedding the extracted feature map into said embedding space.

Step (c) comprises implementation of a k-nearest neighbor algorithm in said embedding space.

The method is a method for classifying a sequence of input images representing said target particle in a sample over time, wherein step (b) comprises concatenation of the extracted feature maps of each input image of said sequence.

According to a second aspect, a system is provided for classifying at least one input image representing a target particle in a sample comprising at least one client comprising data-processing means, characterized in that said data-processing means are configured to implement:
extraction of a feature map of said target particle via analysis of the at least one input image;
reduction of the number of variables of the feature map, by means of the t-SNE algorithm;
unsupervised classification of said input image depending on said feature map having a reduced number of variables.

According to advantageous but non-limiting features, the system further comprises a device for observing said target particle in the sample.

According to third and fourth aspects the following are provided: a computer program product comprising code instructions for executing a method according to the first aspect for classifying at least one input image representing a target particle in a sample; and a storage medium readable by a piece of computer equipment, on which a computer program product comprises code instructions for executing a method according to the first aspect for classifying at least one input image representing a target particle in a sample.

### BRIEF DESCRIPTION OF THE DRAWINGS

Other features and advantages of the present invention will become apparent on reading the following description of a preferred embodiment. This description will be given with reference to the appended drawings, in which:

FIG. 1 is a schematic of an architecture for implementing the method according to the invention;

FIG. 2a shows one example of a device for observing particles in a sample, which device is used in one preferred embodiment of the method according to the invention;

FIG. 3a illustrates obtainment of the input image in one embodiment of the method according to the invention;

FIG. 3b illustrates obtainment of the input image in a preferred embodiment of the method according to the invention;

FIG. 4 shows the steps of a preferred embodiment of the method according to the invention;

FIG. 5a shows one example of a dictionary of elementary images used in a preferred embodiment of the method according to the invention;

FIG. 5b shows one example of extraction of a feature vector and matrix in a preferred embodiment of the method according to the invention;

FIG. 6 shows one example of a convolutional-neural-network architecture used in a preferred embodiment of the method according to the invention;

FIG. 7 represents an example of t-SNE embedding used in a preferred embodiment of the method according to the invention.

### DETAILED DESCRIPTION

Architecture

The invention relates to a method for classifying at least one input image representative of a particle 11a-11f present in a sample 12, referred to as the target particle. It should be noted that the method may be implemented in parallel for all or some of the particles 11a-11f present in a sample 12, each being considered a target particle in turn.

As will be seen, this method may comprise one or more machine-learning components, and in particular one or more classifiers, including a convolutional neural network, CNN.

The input or training data are of the image type, and represent the target particle 11a-11f in a sample 12 (in other words, these are images of the sample in which the target particle is visible). As will be seen, a sequence of images of the same target particle 11a-11f (or where appropriate a plurality of sequences of images of particles 11a-11f of the sample 12 if a plurality of particles are considered) may be provided as input.

The sample 12 consists of a liquid such as water, a buffer solution, a culture medium or a reactive medium (including or not including an antibiotic), in which the particles 11a-11f to be observed are located.

As a variant, the sample 12 may take the form of a, preferably translucent, solid medium such as an agar-agar, in which the particles 11a-11f are located. The sample 12 may also be a gaseous medium. The particles 11a-11f may be located inside the medium or else on the surface of the sample 12.

The particles 11a-11f may be microorganisms such as bacteria, fungi or yeasts. It may also be a question of cells, multicellular organisms, or any other type of particle such as pollutants or dust. In the rest of the description, the preferred example in which the particle is a bacterium (and, as will be seen, the sample 12 incorporates an antibiotic) will be considered. The size of the observed particles 11a-11f varies between 500 nm and a plurality of hundred μm, or even a few millimeters.

The “classification” of an input image (or of a sequence of input images) consists in determining at least one class among a set of possible classes descriptive of the image. For example, in the case of bacteria type particles, a binary classification may be employed, i.e. two possible classes may be employed indicating “division” or “no division”, testifying to the presence or absence of resistance to an antibiotic, respectively. The present invention is not limited to any one particular kind of classification, although the example of a binary classification of the effect of an antibiotic on said target particle 11a-11f will mainly be described.

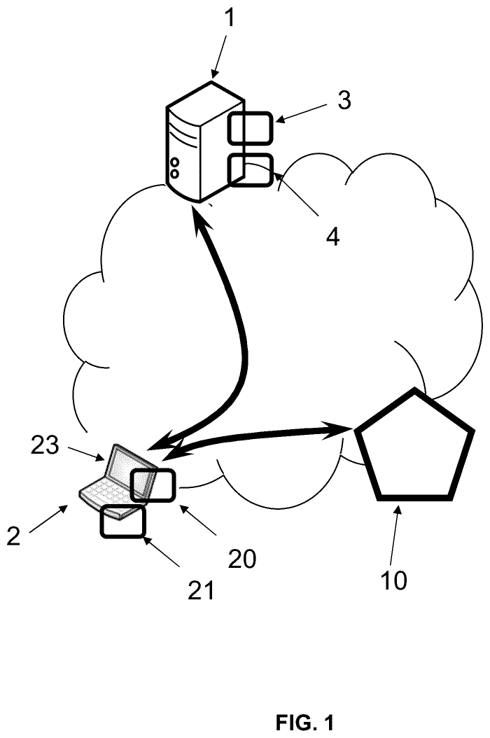

The present methods are implemented within an architecture such as shown in FIG. 1, by virtue of a server 1 and a client 2. The server 1 is the piece of equipment that is trained (implementing the training method) and the client 2 is a piece of user equipment (implementing the classifying method), for example a terminal of a doctor or of a hospital.

It is quite possible for the two pieces of equipment 1, 2 to be combined, but preferably the server 1 is a remote piece of equipment, and the client 2 is a mass-market piece of equipment, in particular a desktop computer, a laptop computer, etc. The client equipment 2 is advantageously connected to an observing device 10, so as to be able to directly acquire said input image (or, as will be seen below, “raw” acquisition data such as an overall image of the sample 12, or even electromagnetic matrices), typically with a view to processing it straight away. Alternatively the input image will be loaded onto the client equipment 2.

In all cases, each piece of equipment 1, 2 is typically a remote piece of computer equipment connected to a local network or to a wide area network such as the Internet with a view to exchanging data. Each comprises data-processing means 3, 20 of the processor type, and data-storing means 4, 21 such as a computer memory, for example a flash memory or a hard disk. The client 2 typically comprises a user interface 22 such as a screen allowing interaction.

The server 1 advantageously stores a training database, i.e. a set of images of particles 11a-11f in various conditions (see below) and/or a set of already classified feature maps (for example associated with labels “divided” or “not divided” indicating sensitivity or resistance to the antibiotic). It should be noted that the training data will possibly be associated with labels defining test conditions, for example indicating, in regard to cultures of bacteria, “strains”, “antibiotic conditions”, “time”, etc.

Acquisition

As explained above, the present method is able to take directly as input any image of the target particle 11a-11f, obtained in any way. However, the present method preferably begins with a step (a) of obtaining the input image from data delivered by an observing device 10.

In a known manner, a person skilled in the art will be able to use DHM techniques (DHM standing for digital holographic microscopy), in particular such as described in international application WO2017/207184. In particular, an intensity image of the sample 12 that is not focused on the target particle (the image is said to be “out of focus”) but that is able to be processed by data-processing means (which are either integrated into the device 10 or those 20 of the client 2 for example, see below) may be acquired, such an image being called a hologram. It will be understood that the hologram “represents” in a certain way all the particles 11a-11f in the sample.

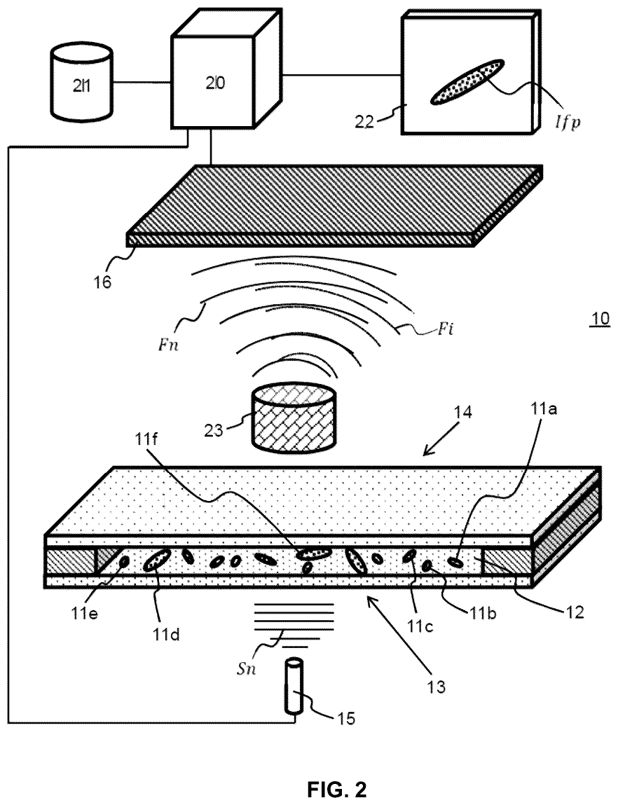

FIG. 2 illustrates an example of a device 10 for observing a particle 11a-11f present in a sample 12. The sample 12 is arranged between a light source 15 that is spatially and temporally coherent (e.g. a laser) or pseudo-coherent (e.g. a light-emitting diode, a laser diode), and a digital sensor 16 sensitive in the spectral range of the light source. Preferably, the light source 15 has a narrow spectral width, for example narrower than 200 nm, narrower than 100 nm or even narrower than 25 nm. In what follows, reference is made to the central emission wavelength of the light source, which for example lies in the visible domain. The light source 15 emits a coherent signal Sn toward a first face 13 of the sample, the signal for example being conveyed by a waveguide such as an optical fiber.

The sample 12 (as explained typically a culture medium) is contained in an analysis chamber that is bounded vertically by a lower slide and an upper slide, for example conventional microscope slides. The analysis chamber is bounded laterally by an adhesive or by any other seal-tight material. The lower and upper slides are transparent to the wavelength of the light source 15, the sample and the chamber allowing for example more than 50% of the wavelength of the light source to pass under normal incidence on the lower slide.

Preferably, the particles 11a-11f are located in the sample 12 next to the upper slide. The bottom face of the upper slide comprises, to this end, ligands allowing attachment of the particles, for example polycations (e.g. poly-L-lysine) in the context of micro-organisms. This makes it possible to contain the particles in a thickness equal to, or close to, the depth of field of the optical system, namely in a thickness smaller than 1 mm (e.g. tube lens), and preferably smaller than 100 μm (e.g. microscope objective). The particles 11a-11f may nevertheless move in sample 12.

Preferably, the device comprises an optical system 23 consisting, for example, of a microscope objective and of a tube lens, placed in the air and at a fixed distance from the sample. The optical system 23 is optionally equipped with a filter that may be located in front of the objective or between the objective and the tube lens. The optical system 23 is characterized by its optical axis; its object plane (also called the plane of focus), which is at distance from the objective; and its image plane, which is conjugated with the object plane by the optical system. In other words, to an object located in the object plane, corresponds a sharp image of this object in the image plane, also called the focal plane. The optical properties of the system 23 are fixed (e.g. fixed focal length optics). The object and image planes are orthogonal to the optical axis.

The image sensor 16 is located, facing a second face 14 of the sample, in the focal plane or in proximity to the latter. The sensor, for example a CCD or CMOS sensor, comprises a periodic two-dimensional array of elementary sensitive sites, and associated electronics that adjust exposure time and zero the sites, in a manner known per se. The signal output from an elementary site is dependent on the amount of radiation in the spectral range incident on said site during the exposure time. This signal is then converted, for example by the associated electronics, into an image point, or “pixel”, of a digital image. The sensor thus produces a digital image taking the form of a matrix of C columns and of L rows. Each pixel of this matrix, of coordinates (c, l) in the matrix, corresponds in a manner known per se to a position of Cartesian coordinates (x(c, l), y(c, l)) in the focal plane of the optical system 23, for example the position of the center of an elementary sensitive site of rectangular shape.

The pitch and fill factor of the periodic array are chosen to meet the Nyquist criterion with respect to the size of the observed particles, so as to define at least two pixels per particle. Thus, the image sensor 16 acquires a transmission image of the sample in the spectral range of the light source.

The image acquired by the image sensor 16 includes holographic information insofar as it results from interference between a wave diffracted by the particles 11a-11f and a reference wave having passed through the sample without interacting with it. It should be obvious, as described above, that, in the context of a CMOS or CCD sensor, the acquired digital image is an intensity image, the phase information therefore here being encoded in this intensity image.

Alternatively, it is possible to divide the coherent signal Sn generated by the light source 15 into two components, for example by means of a semi-transparent plate. The first component then serves as a reference wave and the second component is diffracted by the sample 12, the image in the image plane of the optical system 23 resulting from interference between the diffracted wave and the reference wave.

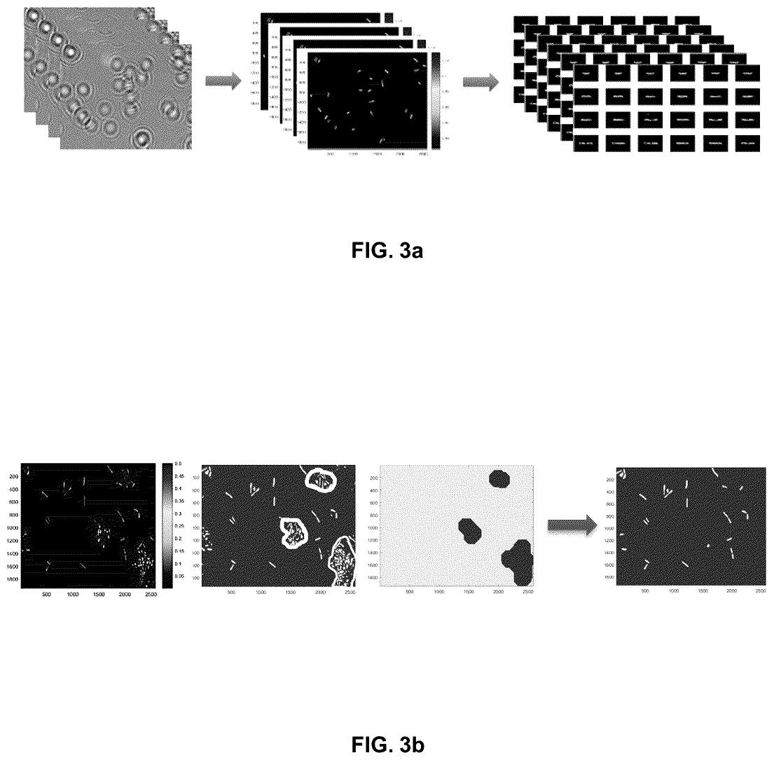

With reference to FIG. 3a, it is possible, in step (a), to reconstruct from the hologram at least one overall image of the sample 12, then to extract said input image from the overall image of the sample.

Specifically, it will be understood that the target particle 11a-11f must be represented in a uniform manner in the input image, and in particular be centered on and aligned in a predetermined direction (for example the horizontal direction). The input images must further have a standardized size (it is also desirable for only the target particle 11a-11f to be seen in the input image). The input image is thus called a “thumbnail”, and its size may for example be defined to be 250×250 pixels. In the case of a sequence of input images, one image is for example taken per minute during a time interval of 120 minutes, the sequence thus forming a 3D “stack” of 250×250×120 size.

The overall image is reconstructed as explained by the data-processing means of the device 10 or those 20 of the client 2.

Typically, a series of complex matrices, called “electromagnetic matrices”, are constructed (for each given acquisition time), these matrices modeling, based on the intensity image of the sample 12 (the hologram), the wavefront of the light wave propagated along the optical axis for a plurality of deviations with respect to the plane of focus of the optical system 23, and in particular deviations positioned in the sample.

These matrices may be projected into real space (for example via the Hermitian norm), so as to form a stack of overall images at various focal distances.

Therefrom it is possible to determine an average focal distance (and select the corresponding overall image, or to recompute it from the hologram), or even to determine an optimal focal distance for the target particle (and again select the corresponding overall image, or to recompute it from the hologram).

In any case, with reference to FIG. 3b, step (a) advantageously comprises segmentation of said one or more overall images so as to detect said target particle in the sample, then cropping. In particular, said input image may be extracted from the overall image of the sample, so as to represent said target particle in said uniform manner.

In general, the segmentation allows all the particles of interest to be detected, while removing artifacts such as filaments or micro-colonies so as to improve the one or more overall images, then one of the detected particles is selected as target particle, and the corresponding thumbnail is extracted. As explained, this may be done for all the detected particles.

The segmentation may be implemented in any known way. In the example of FIG. 3b, first fine segmentation is carried out to eliminate artifacts, then coarser segmentation is carried out to detect the particles 11a-11f. Any segmentation technique known to those skilled in the art may be used.

If it is desired to obtain a sequence of input images for a target particle 11a-11f, tracking techniques may be used to track any movements of the particle from one overall image to the next.

It should be noted that all the input images obtained over time for a given sample (for a plurality of or even all the particles of the sample 12) may be pooled to form a corpus descriptive of the sample 12 (in other words a corpus descriptive of the experiment), as seen on the right of FIG. 3a, this corpus in particular being copied to the storage means 21 of the client 2. This is the “field” level as opposed to the “particle” level. For example, if the particles 11a-11f are bacteria and the sample 12 contains (or does not contain) an antibiotic, this descriptive corpus contains all the information on the growth, the morphology, the internal structure and the optical properties of these bacteria over the whole field of acquisition. As will be seen, this descriptive corpus may be transmitted to the server 1 for integration into said training database.

Feature Extraction

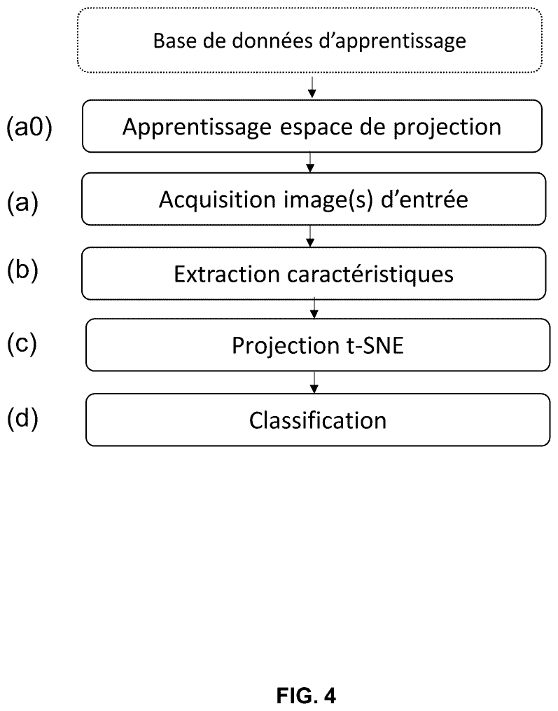

With reference to FIG. 4, the present method is particularly noteworthy in that a step (b) of extraction of a feature map from the input image is carried out separately from a step (d) of classification of the input image depending on said feature map, instead of attempting to classify the input image directly, there being, between these two steps, a step (c) of reduction of the number of variables of the feature map by means of the t-SNE algorithm. More precisely, in step (c) an embedding of the feature map, called the “t-SNE embedding”, is constructed, this constructed embedding having a lower number of variables than the number of variables of the extracted feature map, and advantageously only two or three variables.

In the remainder of the present description, a distinction will be made between the number of “dimensions” of the feature maps in the geometric sense, i.e. the number of independent directions in which these maps extend (for example a vector is an object of dimension 1, and the present feature maps are at least of dimension 2, advantageously of dimension 3, and sometimes of dimension 4), and the number of “variables” of these feature maps, i.e. size in each dimension, i.e. the number of independent degrees of freedom (which in practice corresponds to the notion of dimension in a vector space—more precisely, a set of feature maps having a given number of variables forms a vector space of dimension equal to this number of variables, and similarly for the set of t-SNE embeddings). Step (c) is thus sometimes called the “dimensionality reduction” step, insofar as a first high-dimensional vector space (the feature-map space) is mapped to a second low-dimensional vector space (2D or 3D space), but in practice it is the number of variables that is reduced.

Thus, two examples in which the feature maps extracted at the end of step (b) are respectively: a two-dimensional object (i.e. an object of dimension 2—a matrix) of 60×25 size and thus having 1500 variables; and a three-dimensional object (i.e. an object of dimension 3) of 7×7×512 size and thus having 25088 variables, will be described below. In these two examples, the number of variables is reduced to 2 or 3.

As will be seen, each step may involve an independent learning mechanism that may be (but is not necessarily) automatic, and hence said training database of the server 1 may comprise particle images and feature maps that are not necessarily already classified.

The main step (b) is thus a step of extraction by the data-processing means 20 of the client 2 of a feature map of said target particle, that is to say “coding” of the target particle.

Those skilled in the art may here use any technique for extracting a feature map, including techniques capable of producing massive feature maps with a high number of dimensions (three or even four), since the t-SNE algorithm of step (c) cleverly allows a “simplified” version of the feature map to be obtained, which is then very easy to handle.

A plurality of techniques will now be described that in particular allow a feature map of high semantic level to be obtained without either a large amount of computing power or an annotated database being required.

In the case where a sequence of input images is supplied, step (b) thus advantageously comprises extraction of one feature map per input image, which feature maps may be combined into a single feature map called the “profile” of the target particle. More precisely, the maps all have the same size and form a sequence of maps, so it is enough to concatenate them in the order of the input images to obtain a “high depth” feature map. In such a case, the reduction of the number of variables per t-SNE is even more advantageous.

Alternatively or in addition, the feature maps corresponding to a plurality of input images associated with a plurality of particles 11a-11f of the sample 12 may be summed.

According to a first embodiment of step (b), the feature map is simply a feature vector, and said features are numerical coefficients each associated with one elementary image of a set of elementary images each representing a reference particle such that a linear combination of said elementary images weighted by said coefficients approximates the representation of said particle in the input image.

This is called “sparse coding”. Said elementary images are called “atoms”, and the set of atoms is called a “dictionary”. The idea behind sparse coding is to express any input image as a linear combination of said atoms, by analogy with dictionary words. More precisely, for a dictionary D of size p, and denoting α a feature vector also of size p, the best approximation Dα of the input image x is sought. In other words, denoting α* the optimal vector (the sparse code of the input image x), step (b) consists in solving a problem of minimization of a functional with λ a regularization parameter (which makes it possible to make a compromise between the quality of the approximation and the sparsity of the vector, i.e. to involve the fewest atoms possible). For example, the constrained minimization problem may be stated as follows:

$${α}^{*} ∈ {arg min}_{α ∈ {ℝ}^{p}} [ {‖ α ‖}_{1} t . q . x = D α ]$$

It may also be expressed as a variational-formulation problem:

$${α}^{*} = {arg min}_{α ∈ {ℝ}^{p}} [ \frac{1}{2} {‖ x - D α ‖}_{2}^{2} + λ {‖ α ‖}_{1} ]$$

Said coefficients advantageously have a value in the interval [0, 1] (this is simpler than in R), and it will be understood that in general most of the coefficients have a value of 0, because of the “sparse” character of the coding. Atoms associated with non-zero coefficients are called activated atoms.

Naturally, the elementary images are thumbnails comparable to the input images, i.e. the reference particles are represented therein in the same uniform manner as in the input image, and in particular centered on and aligned in said predetermined direction, and the elementary images advantageously have the same size as the input images (for example 250×250).

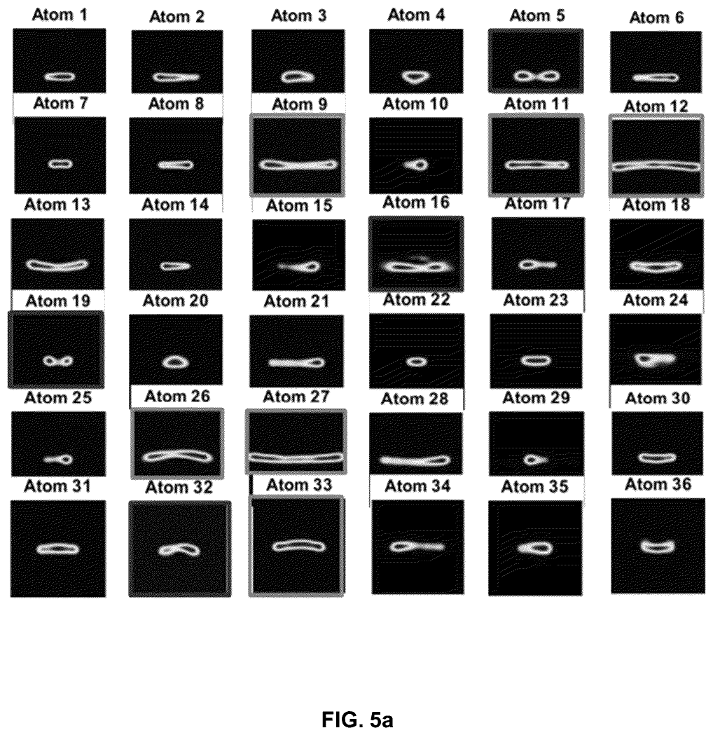

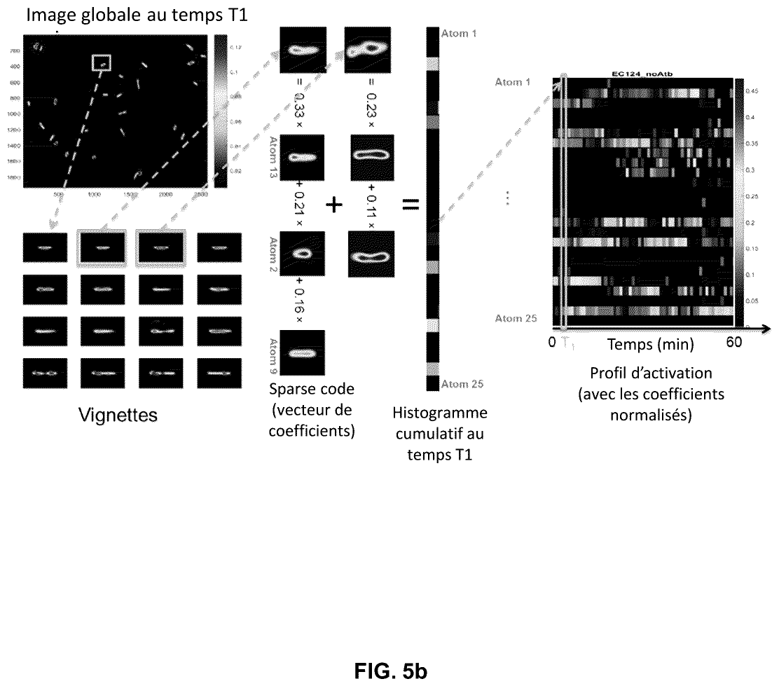

FIG. 5a thus illustrates an example of a dictionary of 36 elementary images (case of the bacterium E. Coli with the antibiotic cefpodoxime).

The reference images (atoms) may be predefined. However, preferably, the method comprises a step (b0) of learning from a training database, in which step reference images (i.e. the images of the dictionary) are learnt, in particular by the data-processing means 3 of the server 1, so that at no point does the method require any human intervention.

This learning method, which is called “dictionary learning” since it involves learning a dictionary, is unsupervised insofar as it does not require the images of the training database to be annotated, and is therefore extremely simple to implement. Specifically, it will be understood that annotating thousands of images by hand would be very time consuming and very expensive.

The idea is simply to provide, in the training database, thumbnails representing particles 11a-11f in various conditions and, based thereon, to find atoms allowing any thumbnail to be represented as easily as possible.

In the case where a sequence of input images is supplied, step (b) advantageously comprises, as explained, extraction of one feature vector per input image, which feature maps may be combined into a feature matrix called the “profile” of the target particle. More precisely, the vectors all have the same size (the number of atoms) and form a sequence of vectors, so it is enough to juxtapose them in the order of the input images to obtain a sparse two-dimensional code (coding spatio-temporal information, hence the two dimensions).

FIG. 5b shows another example of extraction of a feature vector, this time with a dictionary of 25 atoms. The whole of the overall image obtained at a given time T1, and the various extracted input images (corresponding to detected particles), have been shown. Thus, the image representing the 2^{nd} target particle may be approximated as 0.33 times atom 13 plus 0.21 times atom 2 plus 0.16 times atom 9 (i.e. a vector (0; 0.21; 0; 0; 0; 0; 0; 0; 0.16 0; 0; 0; 0.33; 0; 0; 0; 0; 0; 0; 0; 0; 0; 0; 0; 0).

The summed vector, which is called the “cumulative histogram” is shown in the middle. Advantageously, the coefficients are normalized so that their sum is equal to 1. The summed matrix (summation over 60 minutes), which is called the “activation profile”, has been shown on the right—it may be seen that it thus has a size of 60×25.

It will be understood that this activation profile is a high-level feature map representative of the sample 12 (over time).

According to a second embodiment of step (b), a convolutional neural network, CNN, is used to extract the feature map. It will be recalled that CNNs are particularly suitable for vision-related tasks. Generally, a CNN is capable of directly classifying an input image (i.e. of doing steps (b) and (d) at the same time).

Here, decoupling step (b) and step (d) allows use of the CNN to be limited to feature extraction, and, for this step (b), it is possible to solely use a CNN pre-trained on a public image database, i.e. a CNN that has already been trained independently. This is called “transfer learning”.

In other words, it is not necessary to train or retrain the CNN on the training database of images of particles 11a-11f, which may therefore not be annotated. Specifically, it will be understood that annotating thousands of images by hand would be very time consuming and very expensive.

Specifically, to carry out the task of feature extraction, it is enough for the CNN to be discriminating, i.e. able to identify differences between images, including in a public image database that has nothing to do with the current input images. Advantageously, said CNN is an image classification network, insofar as it is known that such networks will manipulate feature maps that are especially discriminating with respect to image classes, and therefore particularly suitable in the present context of particles 11a-11f to be classified, even if this is not the task for which the CNN was originally trained. It will be understood that image detection, recognition or even segmentation networks are particular cases of classification networks, since they in fact carry out the task of classification (of the whole image or of objects in the image) plus another task (such as determining coordinates of bounding boxes of classified objects in the case of a detection network, or generating a segmentation mask in the case of a segmentation network).

As regards the public training image database, the well-known public database ImageNet will for example potentially be used, this database, which contains more than 1.5 million annotated images, being usable to achieve supervised learning of almost any image-processing CNN (for the tasks of classification, recognition, etc.).

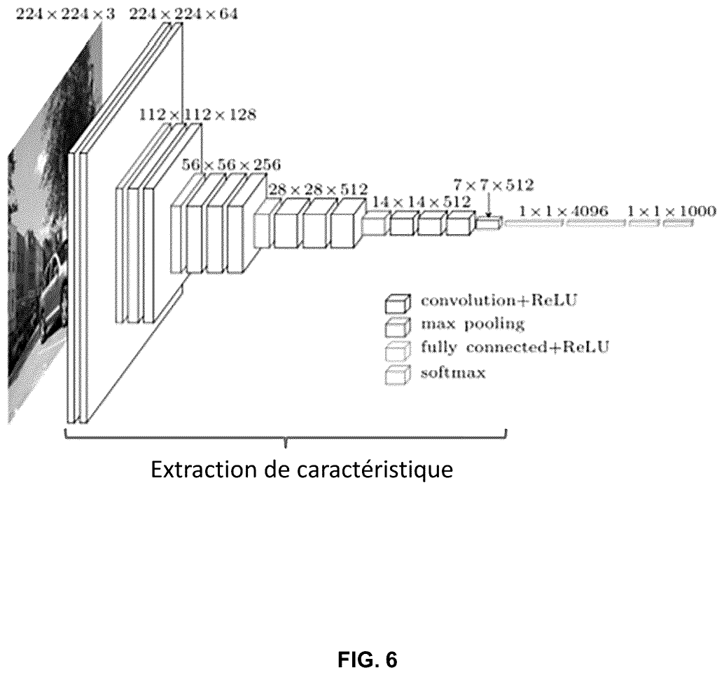

Thus, it will advantageously be possible to use an “off-the-shelf” CNN that does not even need to be trained. Various classification CNNs pre-trained on the ImageNet database (i.e. that may be acquired with their parameters initialized to the correct values as a result of training on ImageNet) are known, for example: the VGG model (VGG standing for Visual Geometry Group) for example the VGG-16 model, AlexNet, Inception, or even ResNet. FIG. 6 represents the VGG-16 architecture (it has 16 layers).

Generally, a CNN consists of two parts:
A feature-extracting first sub-network, most often comprising a succession of blocks composed of convolution layers and of activation layers (for example employing the ReLU function) to increase the depth of the feature maps, these blocks being terminated by a pooling layer allowing the size of the feature map to be reduced (input dimensionality reduction—generally by a factor of 2). Thus, in the example of FIG. 6, the VGG-16 has, as explained, 16 layers divided into 5 blocks. The first, which receives as input the input image (of 224×224 spatial size, with 3 channels corresponding to the RGB character of the image), comprises 2 convolution+ReLU sequences (one convolution layer and one ReLu function activation layer) increasing the depth to 64, then a max-pooling layer (global average pooling may also be used), the output being a feature map of 112×112×64 size (the first two dimensions are the spatial dimensions, and the third dimension is the depth—thus each spatial dimension is divided by two). The second block has an identical architecture to the first block and generates at the output of the last convolution+ReLU sequence a feature map of 112×112×128 size (depth doubled) and as output of the max-pooling layer a feature map of 56×56×128 size. The third block this time has three convolution+ReLU sequences and generates from the last convolution+ReLU sequence a feature map of 56×56×256 size (depth doubled) and as output from the max-pooling layer a feature map of 28×28×256 size. The fourth and fifth blocks have an architecture identical to the third block and successively generate as output feature maps of 14×14×512 and 7×7×512 size (depth no longer increases). This feature map is the “final” map. It will be understood that there are no limits as regards map size at any level, and that the sizes mentioned above are merely examples.
A feature-processing second sub-network, and in particular a classifier if the CNN is a classification network. This sub-network receives as input the final feature map generated by the first sub-network, and returns the expected result, for example the class of the input image if the CNN performs classification. This second sub-network typically contains one or more fully connected (FC) layers and a final activation layer, for example employing the softmax function (which is the case for VGG-16). Both sub-networks are generally trained at the same time in a supervised manner.

Thus, in this second embodiment, step (b) is preferably implemented by means of the feature-extracting sub-network of said pre-trained convolutional neural network, i.e. the first part such as highlighted in FIG. 6 for the example of VGG-16.

More precisely, said pre-trained CNN (such as VGG-16) is not intended to deliver any feature maps, these merely being for internal use. By “truncating” the pre-trained CNN, i.e. by using only the layers of the first sub-network, the final feature map containing the “deepest” information is obtained as output.

It will be understand that it is also entirely possible to employ, as feature-extracting sub-network, a part that terminates before the layer in which the final feature map is generated, for example to employ only blocks 1 to 3 instead of blocks 1 to 5. The information is more extensive but less deep.

In the case where a sequence of input images is supplied, it should be noted that it is possible, instead of extracting one feature map per input image, to combine the maps into a single feature map (by concatenating them in the order of the input images, so as to obtain a “high depth” feature map). It is then possible to make direct use of a so-called 3D CNN, which may be fed with the entire sequence of input images, there then being no need to work image by image.

To do this, step (b) comprises prior concatenation of said input images of the sequence into a three-dimensional or 3D stack, then direct extraction of a feature map of said target particle 11a-11f from the three-dimensional stack by means of the 3D CNN.

The three-dimensional stack is processed by the 3D CNN as a single one-channel three-dimensional object (for example of 250×250×120 size if the input images are 250×250 in size and one image is acquired per minute for 120 minutes—the first two dimensions are conventionally the spatial dimensions (i.e. the size of the input images) and the third dimension is the “time” dimension (time of acquisition)) and not as a multi-channel two-dimensional object (such as is for example used with an RGB image), and hence the output feature map is four-dimensional.

The present 3D CNN uses at least one 3D convolution layer that models the spatio-temporal dependency of the various input images.

By 3D convolution layer, what is meant is a convolution layer that applies four-dimensional filters and that is thus able to work on a plurality of channels of already three-dimensional stacks, i.e. a four-dimensional feature map. In other words, the 3D convolution layer applies four-dimensional filters to a four-dimensional input feature map, so as to generate a four-dimensional output feature map. The fourth and final dimension is semantic depth, as in any feature map.

These layers differ from conventional convolution layers, which are only able to work on three-dimensional feature maps representing a plurality of channels of two-dimensional objects (images).

The notion of 3D convolution may seem counter-intuitive, but it generalizes the convolution-layer notion which merely make provision for a plurality of “filters” of a depth equal to the number of input channels (i.e. the depth of the input feature map) to be applied by scanning them over all the dimensions of the input (in 2D for an image), the number of filters defining the output depth.

Our 3D convolution therefore applies four-dimensional filters of depth equal to the number of channels of the three-dimensional input stacks, and scans these filters over the entire volume of a three-dimensional stack, and therefore not only over the two spatial dimensions but also over the temporal dimension, i.e. over three dimensions (and hence the name 3D convolution). One three-dimensional stack is thus indeed obtained per filter, i.e. a four-dimensional feature map. In a conventional convolution layer, although using a high number of filters certainly increases the semantic depth of the output (the number of channels), the output will always be a three-dimensional feature map.

Reduction of the Number of Variables

The feature map obtained in step (b) (in particular in the case where image sequences are input) may have a very high number of variables (several thousands or even tens of thousands) and hence direct classification would be complex.

As such, in step (c), use of the t-SNE algorithm has two key advantages:
Use of a space of low dimensions (called the embedding space, or sometimes visualization space) and advantageously of two dimensions, allows data to be visualized and manipulated far more simply and intuitively than in the original space of the feature maps;
Above all, unsupervised classification of the input image is possible in step (c), i.e. there is no need to train a classifier.

The trick is that it is possible to construct a t-SNE embedding of the whole training database, i.e. to define the embedding space depending on the training database.

In yet other words, by virtue of the t-SNE algorithm it is possible to represent the feature map of the input image and each feature map of the training database by a two- or three-variable embedding in the same embedding space, such that two feature maps that are close (far apart) in the original space are close (far apart) in the embedding space, respectively.

Specifically, the t-SNE algorithm (t-SNE standing for t-distributed stochastic neighbor embedding) is a non-linear method of achieving dimension reduction for data visualization, allowing a set of points of a high-dimensional space to be represented in a space of two or three dimensions—the data may then be visualized with a scatter plot. The t-SNE algorithm attempts to find a configuration (the t-SNE embedding mentioned above) that is, according to an information-theory criterion, optimal in respect of the proximities of points.

The t-SNE algorithm is based on a probabilistic interpretation of proximities. For pairs of points in the original space, a probability distribution is defined such that points close to one another have a high probability of being selected while points that are far apart have a low probability of being selected. A probability distribution is also defined in the same way for the embedding space. The t-SNE algorithm consists in matching the two probability densities, by minimizing the Kullback-Leibler divergence between the two distributions with respect to the location of the points on the map.

The t-SNE algorithm may be implemented both at the particle level (a target particle 11a-11f with respect to the individual particles for which a map is available in the training database) and at the field level (for the whole sample 12—case of a plurality of input images representing a plurality of particles 11a-11f), in particular in the case of single images rather than of stacks.

It should be noted that t-SNE embedding may be achieved efficiently by virtue in particular of implementation for example in python, and hence it can be carried out in real time. It is also possible, to accelerate the computations and reduce memory footprint, to go through a first step of linear reduction of dimensionality (for example PCA—Principal Component Analysis) before computing the t-SNE embeddings of the training database and of input image in question. In this case, the PCA embeddings of the training database may be stored in memory, all that then remains being to complete embedding with the feature map of the input image in question.

Classification

In a step (c), said input image is classified in an unsupervised manner depending on the feature map having a reduced number of variables, i.e. its t-SNE embedding.

It will be understood that any technique allowing a descriptive analysis of the t-SNE embedding space may be used. Specifically, all the information of the training database is already contained therein, and hence it is enough to look at the spatial configuration of this embedding space to reach a conclusion as to classification.

It is simplest to use the k-NN method (k-NN standing for k-nearest neighbors).

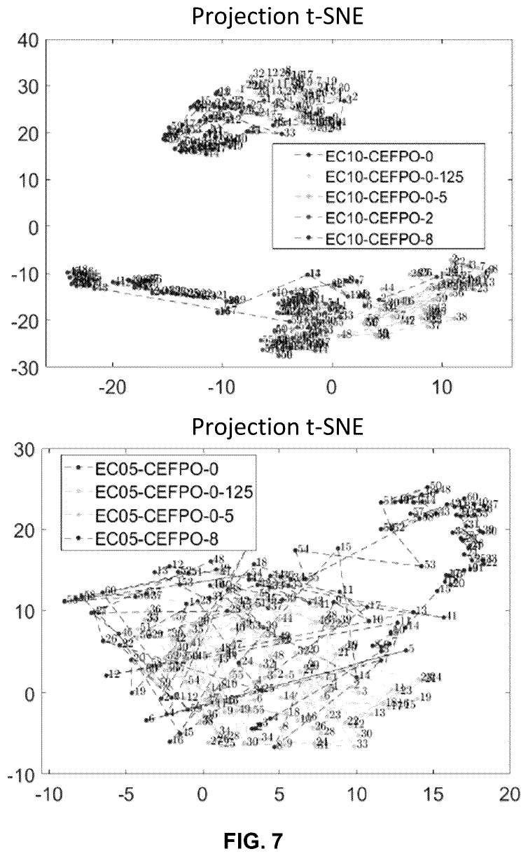

The idea is to look at the neighboring points of the point corresponding to the feature map of the one or more input images in question, and to look at their classification. For example, if the neighboring points are classified “no division”, it may be assumed that the input image in question must be classified “no division”. It should be noted that the neighbors considered may possibly be limited, for example depending on the strain, the antibiotic, etc. FIG. 7 shows two examples of t-SNE embeddings obtained for a strain of E. coli for various concentrations of cefpodoxime. In the top example, two blocks may clearly be seen, visually demonstrating the existence of a minimum inhibitory concentration (MIC) above which morphology and therefore cell division is affected. A vector falling close to the upper part might be classified “division” and a vector falling close to the lower part might be classified “no division”. In the bottom example it may be seen that only the highest concentration stands out (and therefore seems to have an antibiotic effect).

Computer Program Product

According to second and third aspects, the invention relates to a computer program product comprising code instructions for executing (in particular on the data-processing means 3, 20 of the server 1 and/or of the client 2) a method for classifying at least one input image representing a target particle 11a-11f in a sample 12, as well as storage means readable by a piece of computer equipment (a memory 4, 21 of the server 1 and/or of the client 2), on which this computer program product is stored.

1. A method for classifying at least one input image representing a target particle in a sample, the method being characterized in that it comprises implementation, by data-processing means of a client, of steps of:
(b) extraction of a feature map of said target particle from the input image;
(c) reduction of the number of variables of the extracted feature map, by means of the t-SNE algorithm;
(d) unsupervised classification of said input image depending on said feature map having a reduced number of variables.

2. The method as claimed in claim 1, wherein the particles are represented in a uniform manner in the input image and in each elementary image, and in particular centered on and aligned in a predetermined direction.

3. The method as claimed in claim 2, comprising a step (a) of extracting said input image from an overall image of the sample, so as to represent said target particle in said uniform manner.

4. The method as claimed in claim 3, wherein step (a) comprises segmentation of said overall image so as to detect said target particle in the sample, then cropping of the input image to said detected target particle.

5. The method as claimed in claim 3, wherein step (a) comprises obtaining said overall image from an intensity image of the sample, said image being acquired by an observing device.

6. The method as claimed in claim 1, wherein said feature map is a vector of numerical coefficients each associated with one elementary image of a set of elementary images each representing a reference particle, step (a) comprising determination of numerical coefficients such that a linear combination of said elementary images weighted by said coefficients approximates the representation of said target particle in the input image.

7. The method as claimed in claim 1, wherein said feature map of said target particle is extracted in step (b) by means of a convolutional neural network trained beforehand on a public image database.

8. The method as claimed in claim 1, wherein step (c) comprises, by means of said t-SNE algorithm, definition of an embedding space for each feature map of a training database of already classified feature maps of particles in a sample and for the extracted feature map, said feature map having a reduced number of variables being the result of embedding the extracted feature map into said embedding space.

9. The method as claimed in claim 8, wherein step (d) comprises implementation of a k-nearest neighbor algorithm in said embedding space.

10. The method as claimed in claim 1, for classifying a sequence of input images representing said target particle in a sample over time, wherein step (b) comprises concatenation of the extracted feature maps of each input image of said sequence.

11. A system for classifying at least one input image representing a target particle in a sample comprising at least one client comprising data-processing means, characterized in that said data-processing means are configured to implement:
extraction of a feature map of said target particle via analysis of the at least one input image;
reduction of the number of variables of the feature map, by means of the t-SNE algorithm;
unsupervised classification of said input image depending on said feature map having a reduced number of variables.

12. The system as claimed in claim 11, further comprising a device for observing said target particle in the sample.

13. A computer program product comprising code instructions for executing a method as claimed in claim 1, for classifying at least one input image representing a target particle in a sample, when said program is executed on a computer.

14. A storage medium readable by a piece of computer equipment, on which a computer program product comprises code instructions for executing a method as claimed in claim 1 for classifying at least one input image representing a target particle in a sample.
